(19) United States
(12) Patent Application Publication
(10) Pub. No.: US 2005/0065871 A1
(43) Pub. Date: Mar. 24, 2005

(54) Collateralized loan market systems and methods

(75) Inventors: Douglas W. Gerhart, Toronto (CA); Joanna T. Liczyk, Toronto (CA); Douglas E. Steiner, Toronto (CA)

Correspondence Address: Finnegan, Henderson, Farabow,;Garrett & Dunner, L.L.P., 1300 I Street, N.W., Washington, DC, 20005-3315, US

(73) Assignee: NuCenz Technologies, Inc.

(21) Appl. No.: 10/667,459

(22) Filed: Sep. 23, 2003

(51) Int. Cl. G06F 17/60

(52) U.S. Cl. 705/38

(57) ABSTRACT

Systems, methods, and programs consistent with the present invention create a market for lenders and borrowers to negotiate, create, and service collateral-secured loans of differing structures. Embodiments consistent with the invention provide an automated framework for borrowers and lenders to create offers to borrow and/or lend a specified quantity of a specified asset for a specified term at a specified interest rate using a specified quantity of another specified fungible asset as collateral. Borrowers and lenders receive information on the loan market, such as the best offers to lend and the best offers to borrow, and can formulate their own offers accordingly. If an offer to lend and an offer to borrow are compatible, a loan transaction may be automatically initiated between the lender and borrower. Ongoing loan transactions may be automatically serviced throughout the loan's life according to the negotiated terms of the loan.

### FIELD OF THE INVENTION

This invention generally relates to automated systems for creating a collateralized loan market, and more particularly, to systems and methods for negotiating, creating, and servicing loans that use fungible assets as collateral.

### BACKGROUND OF THE INVENTION

Borrowing and lending are basic human activities that have gone on since the beginning of recorded history. Typically, a borrower and a lender negotiate the terms of a loan bilaterally, face-to-face. But to try to get the best terms, a borrower may shop around by conducting negotiations with more than one lender simultaneously. When this happens, any one particular lender has no direct, reliable knowledge of the offers being made by other lenders to a particular borrower. Similarly, a particular borrower has no direct, reliable knowledge of the offers being made by any of the lenders to other borrowers. Both the lender and the borrower could benefit from this type of information. Economic theory predicts that the limited disclosure of pricing information during this type of negotiation process will ultimately result in inefficient pricing of the loan transaction.

In many loan transactions, it is common practice for the borrower to provide the lender with some form of collateral asset that will become the property of the lender if the borrower fails to return the borrowed asset at the maturity of the loan, i.e., if the borrower defaults. Currently, it is very difficult to competitively establish the value of a particular asset as collateral for a loan because lenders and valuing similar assets as collateral. Again, this causes inefficiency in a loan transaction. To most businesses, collateral is a scarce resource that must be used in as efficient a manner as possible.

Another inefficiency in lending decisions stems from the factors considered when deciding whether to enter into a loan with a borrower and setting the loan terms. For example, typically a lender's decision on whether to enter into a loan transaction, such as a real estate mortgage transaction, is based at least in part on the borrower's creditworthiness, reflected in a credit history or credit report. Lenders also typically offer less favorable loan terms to borrowers with a bad credit rating, compared to borrowers with good credit. The borrower's creditworthiness, however, is largely irrelevant if the borrower is willing to put up sufficient collateral to secure the loan because the lender receives the collateral should the borrower default. This is especially true if the lender experiences minimal transaction costs in case of a default. Yet, a bad credit history often prevents loans from being made, in spite of an offer to put up sufficient collateral.

Accordingly, it is desirable to increase the transparency of the price negotiations in a loan transaction and thereby increase the pricing efficiency of the market for loans. It is also desirable to competitively determine the value of a particular asset as collateral for a loan and consequently improve the efficiency with which a borrower may allocate collateral to support loans. Further, it is desirable to provide secured loans based on the quality of the borrower's collateral instead of the quality of the borrower's credit rating.

### SUMMARY OF THE INVENTION

In accordance with the principles of the present invention, a market for collateralized loans enables lenders to offer to lend a specified asset under specified terms secured by a specified collateral asset and enables borrowers to ask to borrow a specified asset under specified terms secured by a specified collateral asset. The market matches lenders and borrowers based on the assets, terms, and collateral specified by each, resulting in an efficient loan transaction.

According to the present invention, a system for managing a market for collateralized loans, comprises a database comprised of entries of borrowing and lending information, wherein each entry for borrowing information includes data identifying a desired loan asset, data identifying collateral for the desired loan asset, and a unique identification of a borrower, and wherein each entry for lending information includes a unique identification of a lender and data specifying conditions under which the lender will supply a loan to a borrower, and wherein the borrowing and lending information from the database is made available to borrowers and lenders; and a computer for maintaining and querying the database and for receiving a query, and in response to the query, the computer determining whether the query constitutes an offer to borrow or an offer to lend an asset, based on a result of the determination, locating in the database a set of entries that match attributes of the offer; upon locating a match, creating a secured loan between any borrowers or lenders identified by the set of entries that match attributes of the offer and a borrower or lender specified by the offer, using any collateral identified in the set of entries that match attributes of the offer when it is determined that the query determined that the query constitutes an offer to borrow, regardless of any determination concerning whether the borrower is able to repay the secured loan; and notifying parties concerning the secured loan.

Other embodiments according to the present invention include a method, system, and computer program for creating a market for collateralized loans comprising receiving a plurality of offers to borrow, wherein each offer to borrow has attributes including a desired loaned asset, a fungible collateral asset, and a borrower identity; providing, to a plurality of lenders, information about the plurality of offers to borrow; receiving a plurality of offers to lend, wherein each offer to lend has attributes including a loaned asset, a desired fungible collateral asset, and a lender identity; providing, to a plurality of borrowers, information about the plurality of offers to lend; matching an offer to lend from the plurality of offers to lend with an offer to borrow from the plurality of offers to borrow based solely on the attributes of the offer to lend and the attributes of the offer to borrow; and creating a secured loan between a lender and a borrower if the lender's offer to lend matches the borrower's offer to borrow.

Many objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and together with the description, serve to further explain the invention.

FIG. 1 is a flow chart illustrating a process for borrowers and lenders to negotiate a loan transaction using an automated marketplace consistent with the present invention;

FIG. 2 is an exemplary offer entry dialog box such as may be presented by a system consistent with the present invention;

FIG. 3 is an exemplary market status report such as may be generated by a system consistent with the present invention;

FIG. 4 is a flow chart illustrating a loan servicing process consistent with the present invention;

FIG. 5 is a diagram depicting a system consistent with the present invention;

FIG. 6 is a more detailed diagram of the Participant Apparatus illustrated in FIG. 5;

FIG. 7 is a more detailed diagram of the Loan Processing Apparatus illustrated in FIG. 5;

FIG. 8 is a more detailed diagram of the Loan Processing Server depicted in FIG. 7;

FIG. 9 is a flow chart of an exemplary process performed by the Event Processor illustrated in FIG. 8;

FIG. 10 is a flow chart of an exemplary process consistent with the Process Timer Event box illustrated in FIG. 9;

FIG. 11 is a flow chart of an exemplary process consistent with the Process Loan Commencement Event box illustrated in FIG. 10;

FIG. 12 is a flow chart of an exemplary process consistent with the Process End of Day Event box illustrated in FIG. 10;

FIG. 13 is a flow chart of an exemplary process consistent with the Process Loan Maturity Event box illustrated in FIG. 10;

FIG. 14 is a flow chart of an exemplary process consistent with the Process Collateral Check Event box illustrated in FIG. 10;

FIG. 15 is a flow chart of an exemplary process consistent with the Process Web Request box illustrated in FIG. 9; and

FIG. 16 is a flow chart of an exemplary process consistent with the Process New Offer To Lend box illustrated in FIG. 15.

### DETAILED DESCRIPTION

Reference will now be made in detail to exemplary embodiments of the invention, examples of which are illustrated in the accompanying drawings. Wherever convenient, the same reference numbers will be used throughout the drawings to refer to the same or like parts.

Overview

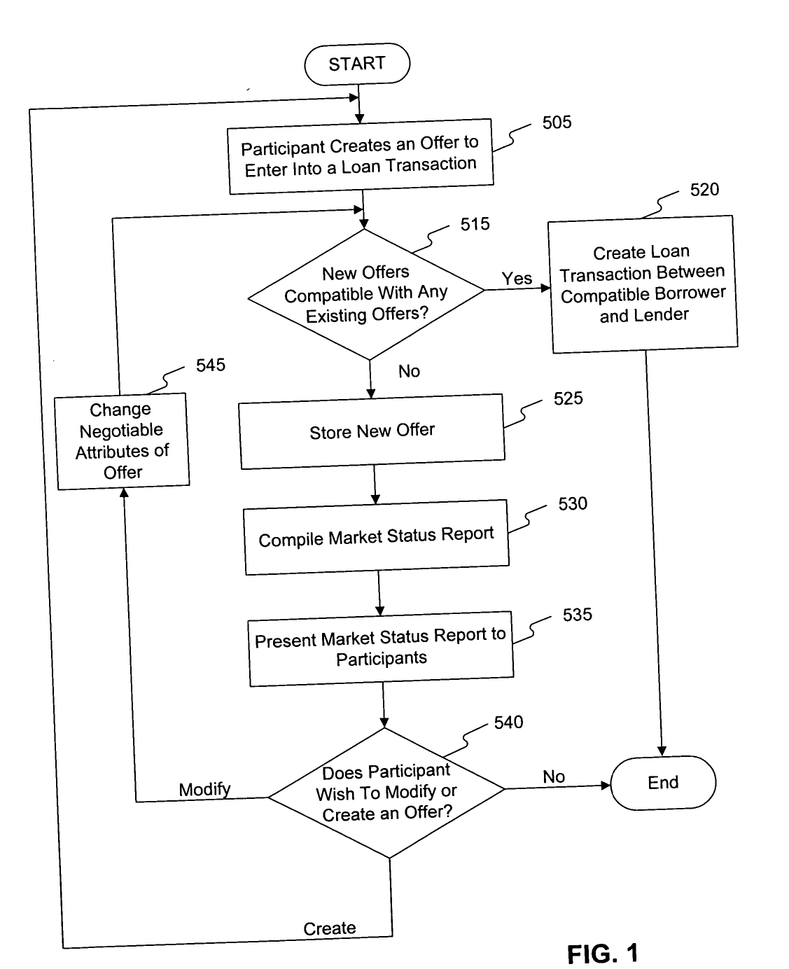

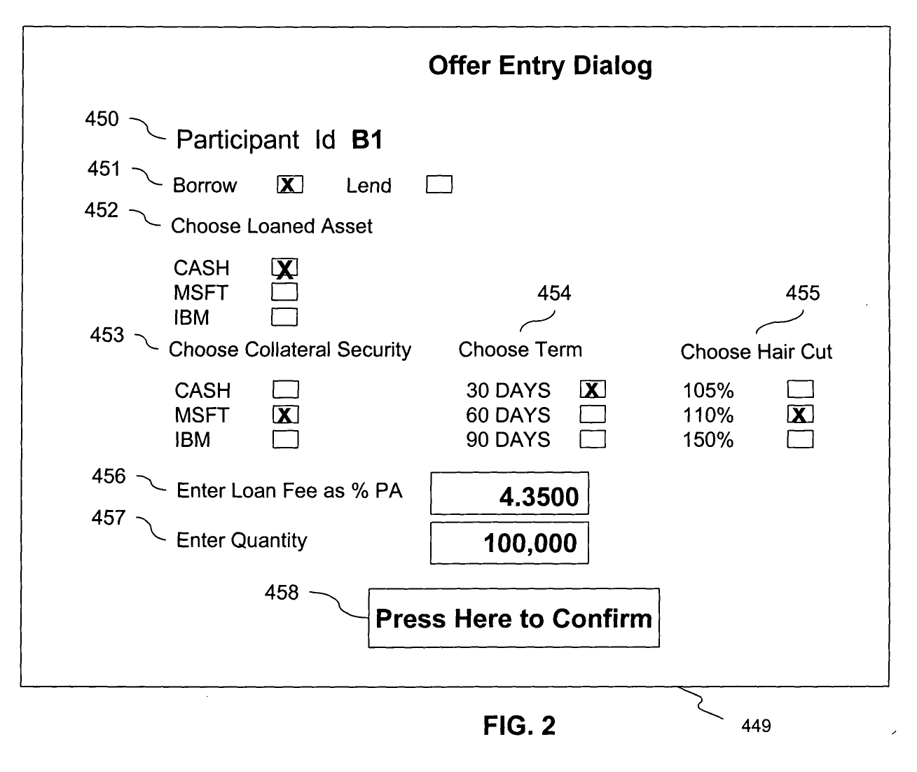

FIG. 1 is a flow chart illustrating a process, implemented using at least one computer under control of an operator, for borrowers and lenders to negotiate and initiate a loan transaction in an automated marketplace consistent with the present invention. The process begins when a participant, who may be either a borrower or a lender, creates an offer to enter into a loan transaction (step 505). For example, a participant who wishes to borrow cash may create one or more offers to enter into a loan transaction as a cash borrower. As part of the offer, the borrower may specify certain negotiable attributes or parameters of the loan transaction that he or she is willing to enter into, such as the loan term, the loan fee, the amount of the loan, and the collateral asset the borrower will put up to secure the loan. Negotiable attributes refer to the loan parameters or terms that a participant can set and modify. In one embodiment consistent with the present invention, the borrower participant creates an offer and specifies loan terms using an offer entry dialog box presented by a computer system, such as is illustrated in FIG. 2. Typically, a participant is a legal entity able and willing to enter into legally binding loan transactions consistent with the invention. In these descriptions, potential participants, i.e., those who have not yet actually submitted an offer to borrow or lend, are also referred to as participants for simplicity.

Next, the process compares the new offer or offers to borrow with all outstanding offers to lend (step 515). Conversely, if the participant had entered an offer or offers to lend, then the process would compare them to all outstanding offers to borrow. If the new offer to borrow has negotiable attributes or terms that are compatible with those of an offer to lend (step 515, yes), (or the new offer to lend has negotiable terms that are compatible with those of an offer to borrow), then a loan transaction between the borrower and a compatible lender is created (step 520). In one embodiment consistent with the invention, two offers may be considered compatible with each other even though their negotiable terms do not match exactly. For example, a borrower who has offered to pay a 4.35% loan fee may be considered compatible with a lender who has offered to accept a 4.25% loan fee.

In one embodiment consistent with the invention, an automated system, such as a computer system, creates the loan transaction between the lender and borrower. For example, upon detecting that an offer to lend and an offer to borrow have compatible negotiable attributes, the automated system creates a pending loan transaction and establishes a date and time at which the pending loan will commence. Using email messages or other communications, the system advises the borrower of the date and time of commencement and the quantity of collateral asset that the borrower must deliver to the account of a specified custodian, such as the operator, prior to the commencement of the loan. Collateral assets such as common stock are typically held for owners by one or more custodial service providers, and the borrower may easily deliver the collateral to the specified custodian by issuing appropriate transfer instructions to the custodial service provider currently holding the assets. In this embodiment, the system also advises the lender of the date and time of loan commencement and the quantity of loaned asset that the lender must deliver to an account of the operator (or other custodian) prior to commencement of the loan.

If at the time of planned loan commencement either the borrower or lender has failed to deliver the required assets, the system will advise the lender and the borrower via email (or some other communication) that the loan will not commence as planned and will return any assets already delivered in anticipation of the pending loan to their owners. If, on the other hand, the operator (or other custodian) is in possession of the required quantity of collateral assets and the required quantity of loaned assets at the time of planned commencement, the system will cause the loaned assets to be transferred to an account of the borrower, for example, by instructing a custodial service provider to do so, and cause the transfer of the collateral assets to a trust account in the name of the operator, or a similar trust account custodian.

Upon successful creation of a loan transaction, the system notifies the borrower and the lender via email or other communications, providing the facts describing the transaction.

One embodiment consistent with the present invention uses a binding legal framework to implement the described systems and methods. In this embodiment, one or more legal agreements between the operator, the participants and any custodial service providers create the legal framework, which is designed to protect the interests of the parties. The legal agreements give legal force to the loan transactions created between the parties and provide legal means for the systems and methods to function as described. The particulars of these agreements are typically tailored to the legal jurisdiction in which a system consistent with the invention operates and to the commercial needs of the operator and other parties.

Referring again to FIG. 1, if the new offer is not compatible with any existing offers (step 515, no), then the computer stores the new offer or offers for future comparison with future new offers to borrow or lend (step 525).

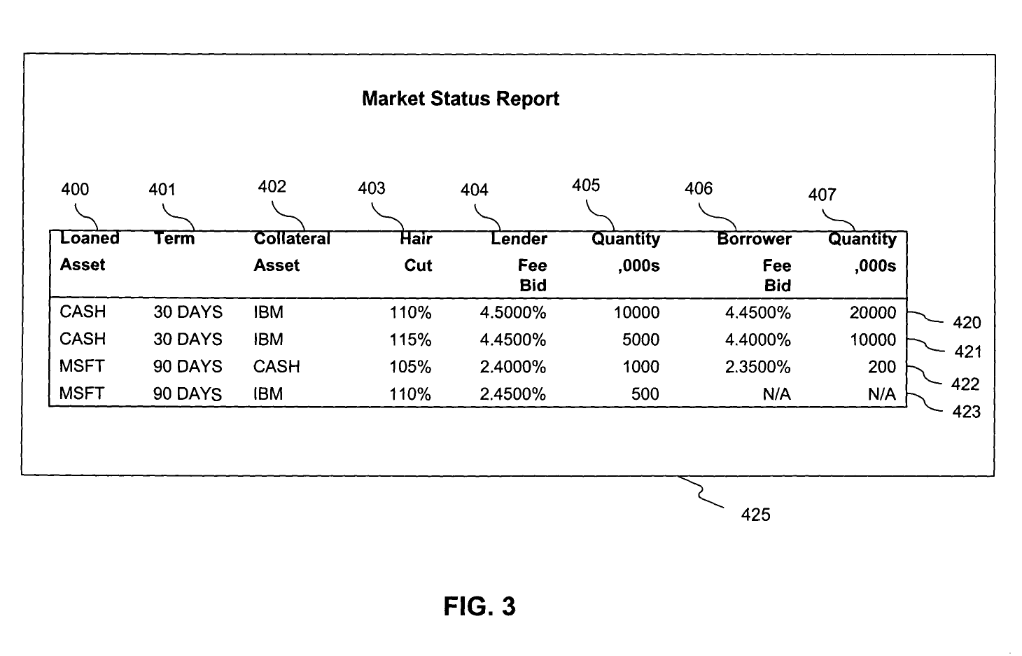

Next, the computer compiles a market status report from the stored offers (step 530). The computer presents the market status report to participants, for example by displaying the report on a screen, printing out a hardcopy, sending a voice message to participants, or otherwise making the information available to participants (step 535). In one embodiment consistent with the invention, the market status report is displayed to participants in the format illustrated in FIG. 3.

By means of the market status report, any participant may obtain information about the offers to borrow and lend outstanding in the marketplace at a given point in time and use this information to formulate a competitive response if desired. If a participant wishes to modify one or more of their currently outstanding offers (step 540, modify), then the participant changes one or more of their offer's negotiable attributes (step 545), and the process treats the modified offer like a new offer (step 515). To allow the participant to change negotiable attributes, the computer may present a user interface similar to the offer entry dialog box shown in FIG. 2, but customized for existing offers. A user may also delete an outstanding offer entirely, instead of modifying it. Well known security and/or access protocols may be used to ensure that a participant does not modify or delete offers made by other users.

If a participant wishes to create one or more new offers (step 540, create), then the process loops back up to step 505. Otherwise, the process ends, until another new offer is created. By considering the information presented in the market status report and creating, deleting, and modifying offers based on the information, participants engage in anonymous negotiation of loan terms with other participants. That is, by changing the negotiable attributes of an offer or creating a new offer in response to pending marketplace offers presented in the market status report, a participant in effect makes counteroffers to the offers pending in the marketplace and thus negotiates with other participants to set the terms of a loan.

One of ordinary skill will recognize that the process shown in FIG. 1 can easily be changed by adding, deleting, or modifying steps without departing from the principles of the present invention. For example, participants could consult a market status report (step 535) before creating an offer for the first time (step 505), or a participant could delete or change the attributes of their outstanding offer (step 545) without having to first go through the other steps shown in FIG. 1, or the entire process could loop into a wait state triggered by a new offer to enter into a loan transaction.

FIG. 2 shows an exemplary offer entry dialog box 449 such as may be presented by a system consistent with the present invention. Using this dialog box 449, a participant enters offers to borrow and lend, specifying the negotiable parameters or attributes of the offer. As shown in FIG. 2, the participant making the offer is identified in a Participant ID field 450. In this example, the Participant ID is “B1.” The participant indicates whether the offer is an offer to borrow or an offer to lend by selecting an appropriate check box 451. In the illustrated example of FIG. 2, the participant is a borrower. The participant chooses the negotiable attribute called loaned asset (i.e., the class of asset to be loaned, which in this case is what the participant wishes to borrow) using the Loaned Asset check boxes 452. The participant selects the negotiable attribute called collateral asset (i.e., the class of the asset to be provided as collateral) using checkboxes 453. The participant selects the loan term negotiable attribute using the Term check boxes 454. The participant selects the desired hair cut negotiable attribute (i.e., the multiple by which the aggregate value of the collateral assets held to secure a loan must exceed the aggregate value of the sum of the loaned assets plus the loan fee) using check boxes 455, enters the loan fee negotiable attribute as an annual interest rate in box 456 (note that the actual fee paid will be prorated based on the term of the loan), and enters the loan quantity negotiable attribute (i.e., the quantity of the asset to be loaned, in this case the number of dollars) in box 457.

In one embodiment consistent with the invention, all other attributes, terms, parameters, and conditions of the loan are fixed, for example according to a predetermined contract, and not the subject of negotiation. In another embodiment, more, fewer, or different attributes than those shown in FIG. 2 are negotiable attributes. In yet other embodiments consistent with the invention, the structure, terms, conditions and negotiable attributes of the loan transactions are dynamically altered to suit a particular purpose during negotiation.

In another embodiment consistent with the invention, after a Participant has entered the desired negotiable parameters, pressing the confirm button 458 sends the contents of the dialog box form to a Loan Process Server 104 (described below) using an HTTP form processing request, as is well-known in the art, for interactive computer applications in a network environment, such as the World Wide Web.

One of ordinary skill in the art will readily recognize that the layout, content, and means of delivery discussed with reference to FIG. 2 could easily be changed in many ways without departing from the principles of the present invention.

FIG. 3 is an exemplary market status report 425 such as may be generated by a system consistent with the present invention. In the embodiment depicted in FIG. 3, the columns of the report correspond to the negotiable parameters of a loan as follows:
The column labeled Loaned Asset 400 depicts a known identifier for a particular class of Loaned Asset, such as cash or Microsoft stock shares;
The column labeled Term 401 is the loan term expressed in days;
The column labeled Collateral Asset 402 depicts a known identifier for a particular class of collateral asset, such as IBM stock shares;
The column labeled Hair Cut 403 expresses the hair cut as a percentage of the loaned amount plus loan fee;
The column labeled Lender Fee Bid 404 depicts the lowest lending fee for which any offers to lend exists for the indicated Loaned Asset 400, Term 401, Collateral Asset 402, and Hair Cut 403;
The column labeled Quantity 405 is the consolidated quantity of the loaned assets available from offers to lend at the lowest lending fee;
The column labeled Borrower Fee Bid 406 depicts the highest lending fee for which an offer to borrow exists for the indicated Loaned Asset 400, Term 401, Collateral Asset 402, and Hair Cut 403; and

The column labeled Quantity 407 is the aggregate loaned quantity desired to be borrowed at the indicated Borrower Fee.

A participant obtains current collateralized loan market conditions by considering the market status report. For example, line 420 depicts the market for loans where the Loaned Asset 400 is cash, the Term 401 is 30 days, the Collateral Asset 402 is IBM common stock and the Hair Cut 403 is 110%. For this combination of attributes, the lowest lending fee any lender is prepared to lend at is a fee that is equivalent to 4.5% per annum (Lender Fee Bid 404), and the quantity of cash offered for loan at that fee is 10,000,000 units (Quantity 405). For these same attributes the highest borrowing fee in any offer to borrow is a fee equivalent to 4.45% per annum (Borrower Fee Bid 406) and at that fee 20,000,000 units (Quantity 407) are in demand from borrowers.

Similarly, line 421 depicts the market for loans similar to line 420, except that the Hair Cut 403 is higher resulting in different fees and quantities.

Line 422 depicts the market for loans where the Loaned Asset 400 is Microsoft common stock, the Term 401 is 90 days, and the Collateral Asset 402 is cash.

Line 423 depicts the market for loans where the Loaned Asset 400 is Microsoft common stock, the Term 401 is 90 day, the Collateral Asset 402 is IBM common stock, and there are one or more offers to lend but no offers to borrow.

Thus, in the embodiment depicted in FIG. 3, the market status report shows the best offer to lend and the best offer to borrow for each particular combination of Loaned Asset 400, Term 401, Collateral Asset 402, and Hair Cut 403. In this embodiment, where there are multiple best offers the Loaned Quantities are summed. For a particular combination of Loaned Asset 400, Term 401, Collateral Asset 402, and Hair Cut 403, the best offer to lend is the offer to lend with the lowest Lending Fee 404 and the best offer to borrow is the offer to borrow with the highest Lending Fee 404. In this embodiment, the displayed offer to lend will always be priced higher than the offer to borrow because for any pair of offers for which this condition was not true a loan transaction would have resulted and the offers would no longer be outstanding and listed on the market status report.

One embodiment consistent with the present invention makes the market status report, or some similar representation of the current outstanding offers, such as a ticker-tape-type presentation, available to borrowers and lenders who are already participating in the market and to the general public. Thus, participants and potential participants know the current “bid” and “ask” prices and other information for the collateralized loan offers currently pending in the marketplace. Based on the market information, participants and newcomers can make informed decisions about borrowing and lending assets. For example, if a participant discovers an attractive outstanding offer in the market, he may place an offer to match the outstanding offer and thus quickly create a loan transaction under the attractive terms. Or, a participant may anonymously negotiate loan terms by submitting an offer with attributes close to, but more attractive than, the terms of an outstanding offer in the market. Or after examining the market offerings, a participant may decide that the current loan market conditions will not bring the best possible rate of return for his asset and employ the asset elsewhere.

One of ordinary skill will recognize that many different presentations consistent with the present invention could be used to convey information about the outstanding offers to borrow and lend in the loan marketplace, and that FIG. 3 represents just one possibility.

Referring again to FIG. 1, when the offers of two participants are compatible, the participants enter into a loan transaction (step 520). In one embodiment consistent with the invention, according to the loan transaction terms, the borrower agrees to borrow from the lender a specified quantity of a specified asset referred to as the loaned asset, the loan is for a specified length of time or term, the borrower agrees to return the loaned asset and pay the lender a lending fee at maturity, and the borrower agrees to provide collateral for the life of the loan.

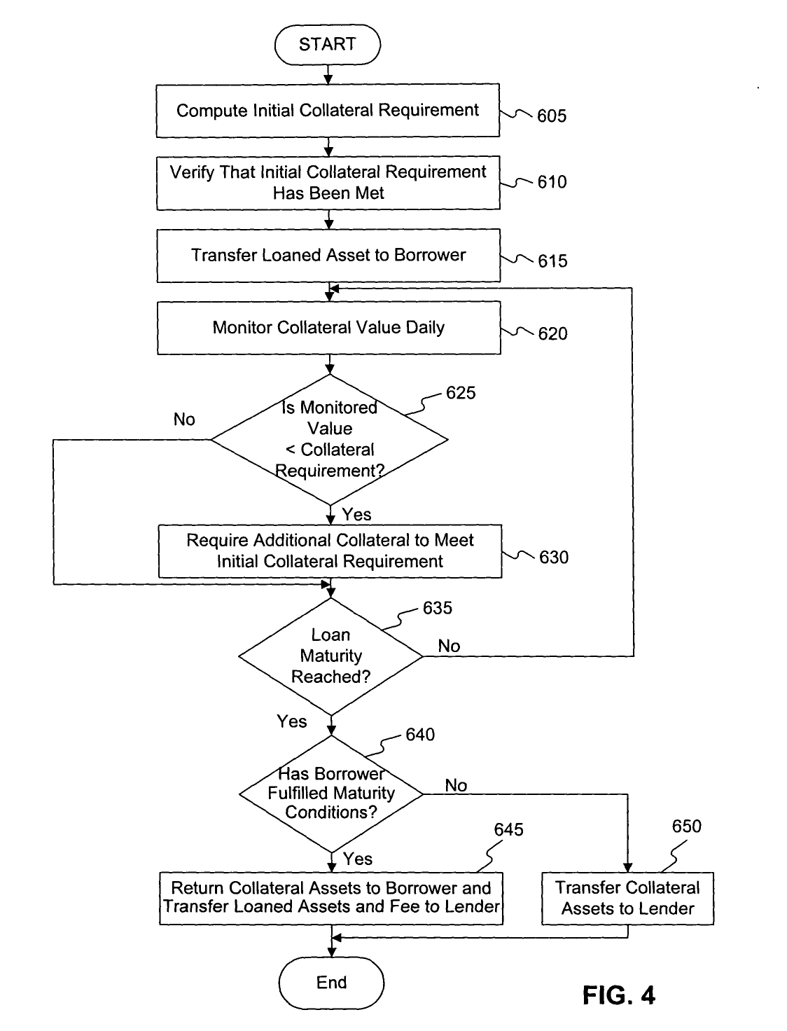

Once a loan transaction is entered into between a borrower and lender, the loan is serviced. That is, the loan is initiated, and the loan's terms and conditions between the buyer and seller are monitored and enforced. FIG. 4 is a flow chart illustrating a loan servicing process consistent with the present invention.

As explained, the loan servicing process is typically performed by an operator using computer systems. Generally, an operator is a legal entity that is responsible for the operation of systems and methods that provide the loan marketplace. In one embodiment, the operator acts as an agent and trustee for borrowers and lenders. As the embodiment of FIG. 4 shows, to start the servicing process, the computer computes the quantity of required collateral at the time the loan is negotiated or originated (step 605). In one embodiment consistent with the invention, the collateral is a specified quantity of a fungible asset, such as a specified quantity of a particular common stock, bond, or cash; and, the specific quantity of collateral required at loan creation is equal to at least the hair cut, which is a specified fixed multiple of the sum of the aggregate value of the loaned assets plus the lending fee, e.g., 110%.

Next, the computer verifies that the computed initial collateral requirement has been met by the borrower (step 610). For example, the computer may issue electronic inquiries to one or more market data service providers to determine the market price of the collateral assets and confirm that that the borrower has deposited the determined quantity of collateral, such as a specified number of shares of IBM stock, with a custodian. In one embodiment, all assets provided as collateral are held in trust for the life of the loan by the system operator, who acts as custodian. In another embodiment consistent with the invention, one or more financial institutions act as custodians. The financial institution and operator may also act as custody service provider, to provide financial asset custody and transfer services by automated means on behalf of the borrowers, lenders, and operator.

After the collateral is verified, the operator causes the transfer of the loaned asset, such as cash, to the borrower (step 615). For example, the operator may cause cash to be wired to the borrowers bank or brokerage account.

At the end of every business day during the term of the loan, the computer monitors the current value of the collateral (step 620). For example, the computer may issue electronic inquiries to one or more market data service providers to determine the market prices of the collateral asset in the public markets, as well as the loaned asset market price if applicable. For instance, if the collateral is shares of common stock, the computer may calculate the aggregate value of the shares held using the stock's closing price. A similar calculation may be done for the loaned asset. Of course, if the loaned asset is cash, a market price calculation is not need.

In that event that the calculated value of the collateral currently provided against the loan is less than the initial collateral requirement based on the agreed-upon hair cut for the loan (step 625, yes), the operator asks the borrower to make up the shortfall, for example, by depositing additional collateral with the collateral custodian within a specified fix interval of time. In one embodiment consistent with the invention, the operator advises the borrower of the short fall by means of an email message and specifies a deadline by which time the shortfall must be remedied to avoid default. In another embodiment consistent with the invention, if the borrower fails to remedy any collateral deficiency by delivering additional collateral to the custodian within the required time limit, the system operator terminates the loan, transfers any collateral currently held for the loan to the lender, and advises both the lender and the borrower via email that the loan has been terminated as a result of collateral deficiency.

If the daily value of the collateral is greater than or equal to the initial collateral value requirement (step 625, no), then the borrower is not required to make an additional deposit.

Next, the computer checks whether loan maturity has been reached, based on the term of the loan (step 635). If maturity has not been reached (step 635, no), than the computer continues to monitor the collateral value day-to-day.

If loan maturity has been reached (step 635, yes), then the operator determines whether the borrower has fulfilled the loan maturity conditions (step 640). For example, typically the borrower must return the loaned assets and pay the lender the agreed lending fee at maturity. In one embodiment consistent with the invention, the borrower must transfer the loaned assets plus the lending fee due at maturity to the custodial account of the operator prior to the maturity deadline.

If the borrower has fulfilled the maturity conditions (step 640, yes), then the operator returns the collateral assets to the borrower and transfers the loaned assets and lending fee to the lender (step 645). If the borrower has not fulfilled the maturity conditions (step 640, no), then the collateral assets are transferred to the lender (step 650). In one embodiment consistent with the invention, the operator issues instructions to one or more custodial service providers to transfer the collateral assets currently held for the loan to the account of the lender and advises both the borrower and lender via email that the loan has been terminated as a result of the borrower's failure to deliver the loaned assets and lending fee at maturity.

In one embodiment consistent with the invention, the assets that are loaned and the assets that are provided as collateral for loans are fungible assets, such as cash and most publicly traded securities, for which ownership can be transferred by electronic means. Real estate, on the other hand, is not a fungible asset. One of ordinary skill will recognize that such ownership transfers are easily accomplished using the existing conventional financial infrastructure. One of ordinary skill will further recognize that the process shown in FIG. 4 can easily be changed by adding, deleting, or modifying steps, including changing steps to achieve different risk profiles for the lending transactions, without departing from the principles of the present invention. For example, the collateral market value could be monitored on a weekly basis or on a real-time basis, or a grace period could be added after the loan maturity deadline to allow the borrower more time to fulfil the maturity conditions.

Loan Processing System

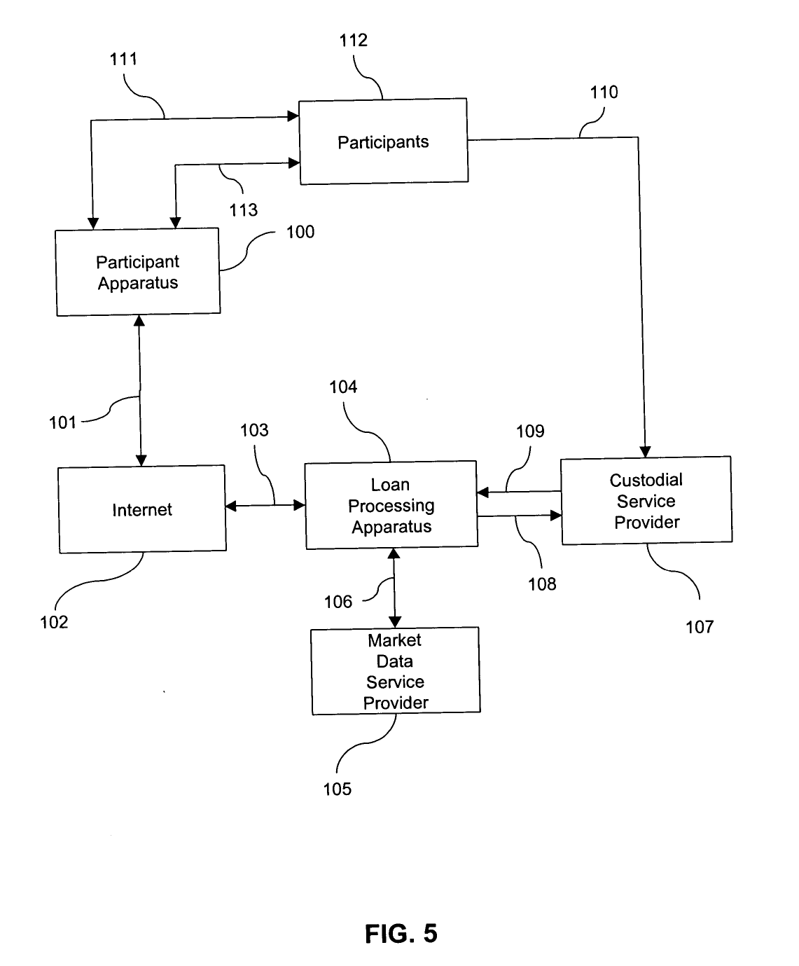

FIG. 5 is a diagram depicting a system consistent with the present invention. The system may be thought of as creating and hosting a collateralized loan market. In the embodiment shown, Participants 112, who may be one or more borrowers and one or more lenders, negotiate loans with each other by creating and modifying offers via an interactive computer application hosted on a Loan Processing Apparatus 104. A Participant 112 communicates with the Loan Processing Apparatus 104 via a Participant Apparatus 100. Participants 112 or other users of Participant Apparatus 100 may be natural persons acting for their own account or acting as agents for other legal entities. Further, it is well within the state of the art to assemble apparatus that could emulate the behavior of a natural person on the Participant Apparatus 100.

The Participant Apparatus 100 connects to the Loan Processing Apparatus 104 via the Internet 102, or other conventional data communications network. As shown, the Participant Apparatus 100 connects to the Internet 102 via an Internet Access Service 101. An Internet Access Service 101 is typically provided by an Internet Service Provider (not shown). The Participants 112 may interact with the Participant Apparatus 100 via email messages 113 and by using a web browser 111. Loan Processing Apparatus 104 and Participant Apparatus 100 host software applications that support these interactions.

In addition, the Loan Processing Apparatus 104 hosts application software that supports negotiating, creating, and servicing of loan transactions. For example, under software control, the Loan Processing Apparatus 104 may make inquiries 106 to a Market Data Service Provider 105 to obtain information. In one embodiment consistent with the invention, the Loan Processing Apparatus 104 must have access to accurate market prices for loaned and collateral assets. The Loan Processing Apparatus 104 obtains assets prices from a Market Data Service Provider 105 by making electronic inquiries 106. The procedure for making electronic inquires to a particular market data service provider are typically unique for each market data service provider. Depending on the universe of loaned and collateral assets involved in the loans created by a particular instance of a system consistent with the present invention, that instance will require at least one and perhaps more Market Data Service Providers 105. The Market Data Service Provider 105 is an entity that provides information concerning the prices of assets in public markets. Reuters is one example of a well-known provider of these services. Beyond the need to provide accurate market prices, the selection of a particular market data service provider is not critical to the invention.

Under software control, the Loan Processing Apparatus 104 may also issues instructions 108 to a Custodial Service Provider 107 to cause an asset to be moved or transferred. Similarly, Participants 112 may issue instructions 110 to a Custodial Services Provider 107 to move or transfer an asset, though Participants 112 often will not use a software application to issue the instructions. When a Participant delivers assets, for example to the custodian account of the operator, the Custodial Service Provider 107 sends notice of the event 109 to the Loan Processing Apparatus 104. Loan Processing Apparatus 104 thus keeps track of the specific assets delivered to the account of the operator, or other custodian.

The Custodial Service Provider 107 holds and moves assets for the system operator and Participants 112. Many well-known banks, trust companies and depository institutions provided custodial services. Ideally, a custodial service provider should be able to legally receive and hold fungible assets in trust for a beneficial owner, and upon instruction from the beneficial owner, deliver fungible assets held in the account of that beneficial owner to the account of another beneficial owner. The exact method of holding assets and conveying instructions to a particular custodial service provider is typically specific to that provider. The particular selection of a Custodial Service Provider 107 is not critical to the invention.

One of ordinary skill will realize that the components depicted in FIG. 5 can be easily added to, deleted, modified, or combined without departing from the principles of the present invention. For example, multiple instances of Market Data Service Providers 105, Custodial Service Data Providers 107, and Participant Apparatuses 100 could be employed, or the entire system shown in FIG. 5 could be duplicated in its entirety to either interact with similar systems or form discrete markets.

Participant Apparatus

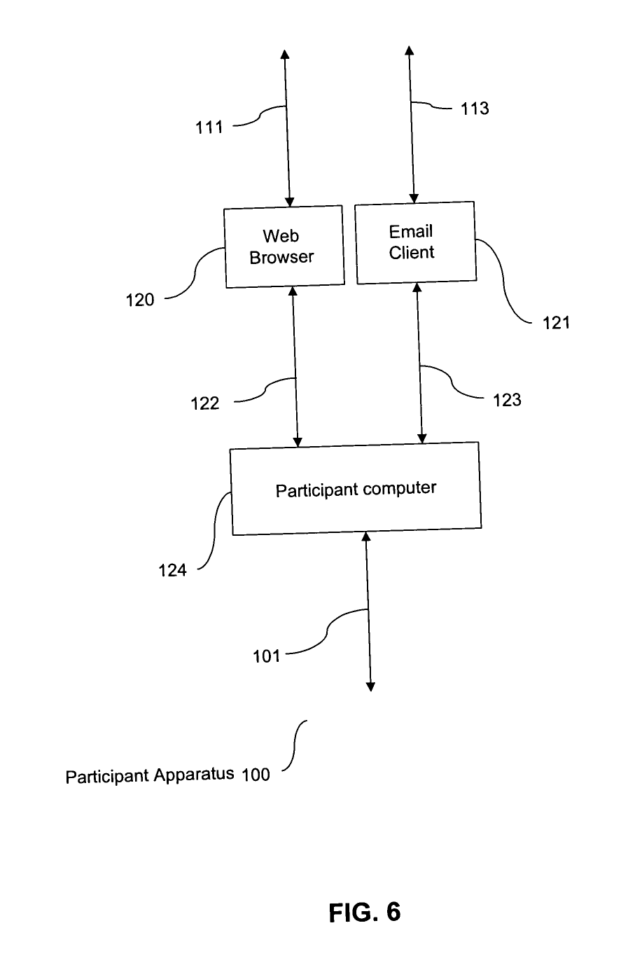

FIG. 6 is a more detailed diagram of the Participant Apparatus illustrated in FIG. 5. In the embodiment shown, a Participant Computer 124 operates Web Browser software 120 and Email Client software 121. The Participant Computer 124 is connected to the Internet 102 (as shown in FIG. 5) through Internet Access Service 101 provided by an Internet Service Provider.

The Participant Computer 124 may be any conventional, commercially available computing device such as a personal computer, desktop computer, lap-top computer, palm computer, or workstation, having sufficient resources and peripheral equipment to properly run the Web Browser 120, the Email Client 121 and support the Internet Access Service 101. A purpose-built computing device could also be used. The exact embodiment of the Participant Computer 124 is not critical to the invention.

The Web Browser 120 may be a conventional web browser software program executing on the Participant Computer 124 and providing conventional web browser capabilities well known in the art. These capabilities include the ability to make request to and receive responses from web servers using standard HTTP and HTML protocols running over TCP/IP. Widely available software products such as Microsoft Internet Explorer™ have these capabilities.

The Email Client 121 is a software program executing on the Participant Computer 124 that provides email capabilities, including the ability to send email and receive email messages using standard SMTP and POP protocols running over TCP/IP protocols. Email programs, such as Microsoft Outlook Express™, are widely available and well known in the art.

Internet Access Service 101 may be a combination of hardware apparatus, software, and services provided by any Internet Service Provider, as are well known in the art.

Participants 112 using Participant Computer 124 may retrieve email messages addressed to them by the Loan Processing Apparatus 104 using the Email Client 121 and otherwise interact 111 with the Loan Processing Apparatus 104 through the Web Browser 120.

Loan Processing Apparatus

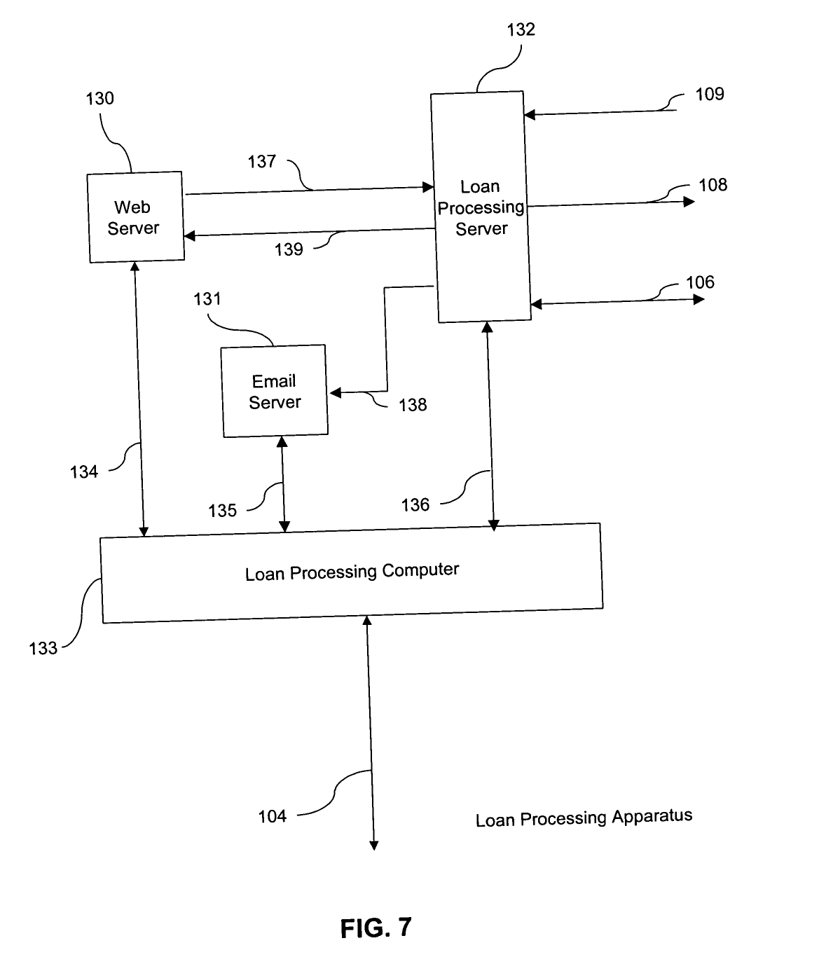

FIG. 7 is a more detailed diagram of the Loan Processing Apparatus illustrated in FIG. 5. As shown in the embodiment of FIG. 7, the Loan Processing Apparatus generally comprises data processing apparatus and applications software. The Loan Processing Computer 133 may be any conventional data processing system. For example, the Loan Processing Computer may comprise an appropriately configured Intel-based processor and peripheral devices running the Microsoft Windows XP operating system. Techniques for appropriately configuring a system such as this are well known in the computer science art.

In the embodiment shown, Web Server 130 is application software which implements the well-known functionality of a web server. The Web Server may be any number of commercially available or open source software products. For example, the Web Server 130 may be a suitably configured instance of the Microsoft Internet Information Server™. The Web Server 130 uses system services 134 provided by the Loan Processing Computer 133. These services include the ability to use the Internet to make a TCP/IP connection with other Internet hosts and operate standard web applications across the connection.

Email Server 131 is application software that manages email services, such as sending and receiving email messages, according to a set of well-known standard protocols. The Email Server 131 may be any number of widely available commercial or open source software products, such a suitably configured instance of the Microsoft Exchange Server™. The Email Server 131 uses system services 135 provided by the Loan Processing Computer 133. These services include the ability to use the Internet to make a TCP/IP connection with other hosts and operate standard email applications across the connection.

Loan Processing Server 132 is application software written to perform custom capabilities that are not typically embodied in widely available commercial or open source software. The Loan Processing Server 132 may be programmed with any number of programming languages or systems, such as the C++ programming language and the Microsoft.NET™ application framework. The Loan Processing Server 132 uses system services 136 provided by Loan Processing Computer 133, including services to interact with the Web Server 130 and the Email Server 131.

The Loan Processing Computer 133 is connected to the Internet 102 via an Internet Access Service 104. The Internet Access Service is provided by hardware, software, and service apparatus from an Internet Service Provider.

The Loan Processing Server 132 processes certain requests 137 received by the Web Server 130 and responds to them 139. In one embodiment, a Microsoft Active Server Page™, which is a standard component of the Microsoft Internet Information Server™ integrated into the Microsoft.NET™ application, can be configured to perform this function.

The Loan Processing Server 132 generates email messages addressed to specific borrower and lender participants as needed. The Loan Processing Server 132 sends these email messages via the Email Server 131. The Loan Processing Server 132 and the Email Server 131 may be linked by software 138 that is a standard component of Microsoft Exchange™.

In one embodiment consistent with the present invention, the Loan Processing Server 132 obtains the market prices of particular assets from time to time by making electronic inquiries 106 to a Market Data Service Provider 105. The exact form of these inquiries is not critical to the invention.

Also from time to time, the Loan Processing Server 132 moves assets from one account to another by issuing instructions 108 to a Custodial Service Provider 107. The specific delivery method and format of these instructions are not critical to the invention.

The Custodial Service Provider 107 (FIG. 5) sends messages 109 to the Loan Processing Server 132, such as a notification message when a Participant 112 deliver assets to an account specified for a loan transaction, such as the account of the operator. The exact format and implementation of the notification message 109 and its delivery are not critical to the invention.

Loan Processing Server

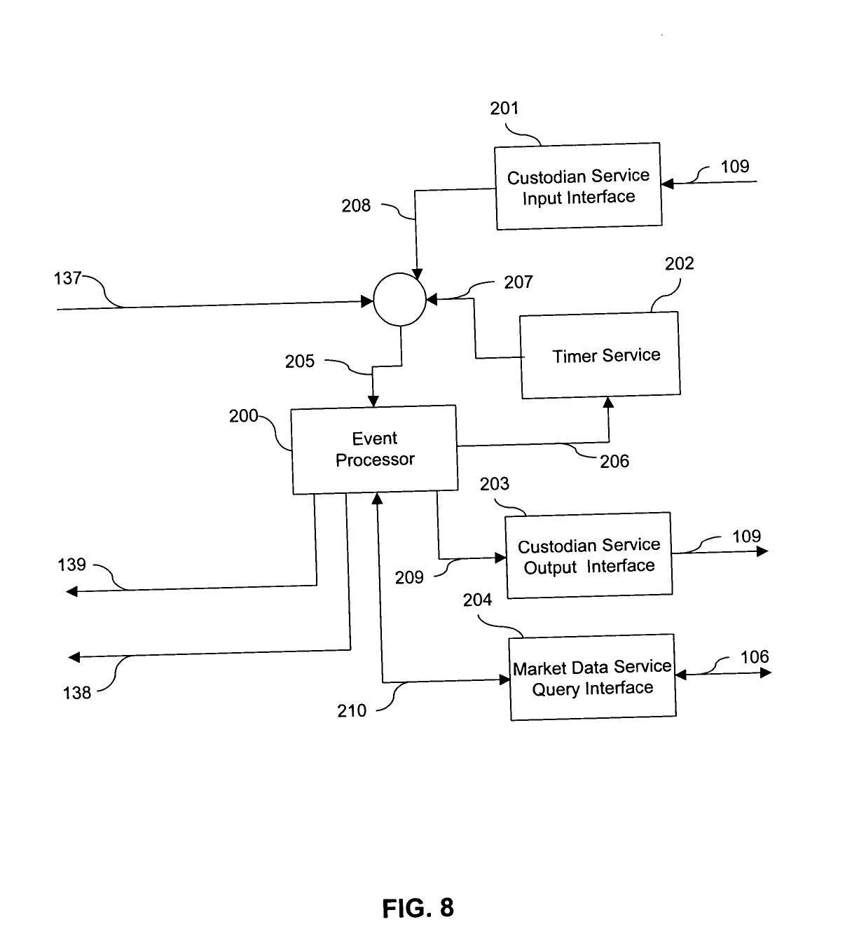

FIG. 8 is a more detailed diagram of the Loan Processing Server depicted in FIG. 7. In the embodiment shown, the Loan Processing Server 132 is a software application based on an event processing model such that when pertinent events occur, the software responds to the events, and otherwise it sits idle waiting for a pertinent event to occur. The logic for processing events is embodied in the Event Processor module 200.

The software events driving the Event Processor 200 are; web requests 137, customer event custodial notifications 208, and software events 207 from the Timer Service 202. These events are consolidated into a logical stream of events 205 for processing by the Event Processor module 200.

The Timer Service 202 is software that accepts requests 206 to perform a particular action at a particular time and then sends a software event 207 to the Event Processor 200 when the appointed time arrives.

A Custodial Service Input Interface module 201 converts custodial event notification messages 109 generated by a Custodial Service Provider into a common customer event notification message format 208 suitable for processing by the Event Processor 200.

A Custodial Service Output Interface module 203 converts general asset movement instruction messages 209 created by the Event Processor 200 into a form suitable for delivery to a specific Custodial Service Provider along path 109.

A Market Data Service Query Interface module 204 converts general asset price queries 210 generated by the Event Processor into a format suitable for processing by a specific Market Data Service Provider on path 106.

Event Processor

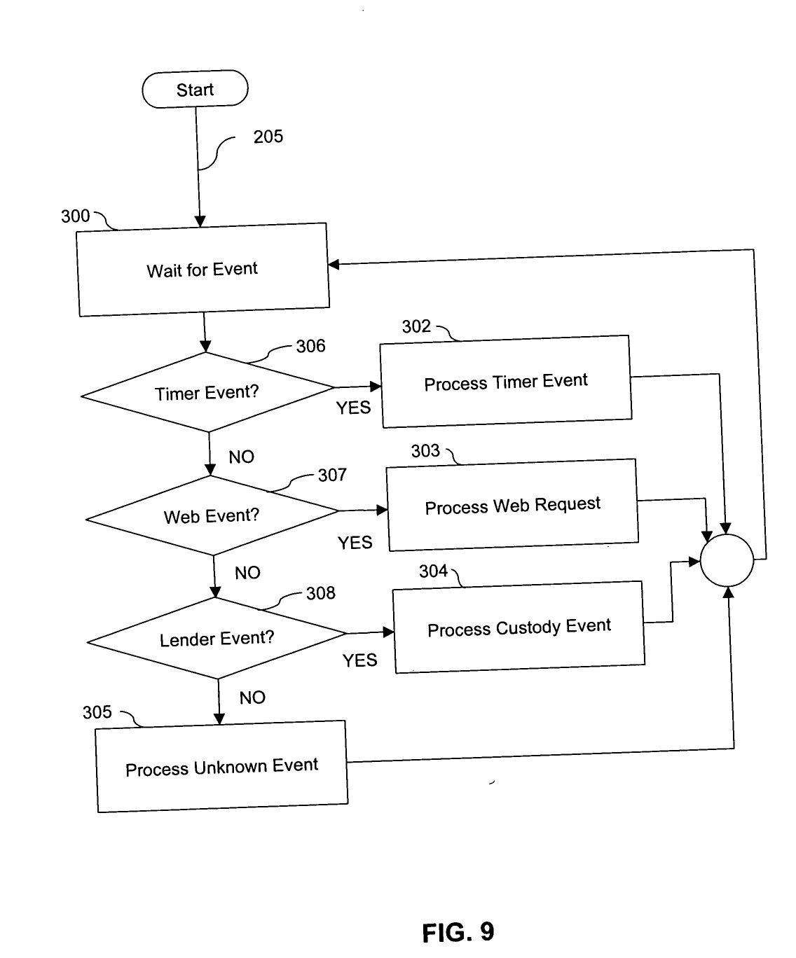

FIG. 9 is a flow chart of an exemplary process performed by the Event Processor illustrated in FIG. 8. In the embodiment shown, the Event Processor 200 waits in a continuous loop for software events 205 to arrive (step 300). Upon arrival, the Event Processor process examines and classifies the software event 205 (steps 306-308). Timer Service software events 207 are dispatched to the Process Timer Event routine 302 for further processing (step 306, yes). Software events representing the arrival of a web request 137 are dispatched to the Process Web Request routine 303 (step 307, yes). Software events 208 from the Custodial Service Input Interface 201 are dispatched to the Process Custody Event routine 304 (step 308, yes). The Process Custody Event routine 304 determines which participant caused the assets to be transferred to the custodian's account and makes a durable record of receipt of the assets. Any software event that cannot be classified as above may be an error and is processed by the Process Unknown Event routine 305 (step 308, no).

Process Event Timer

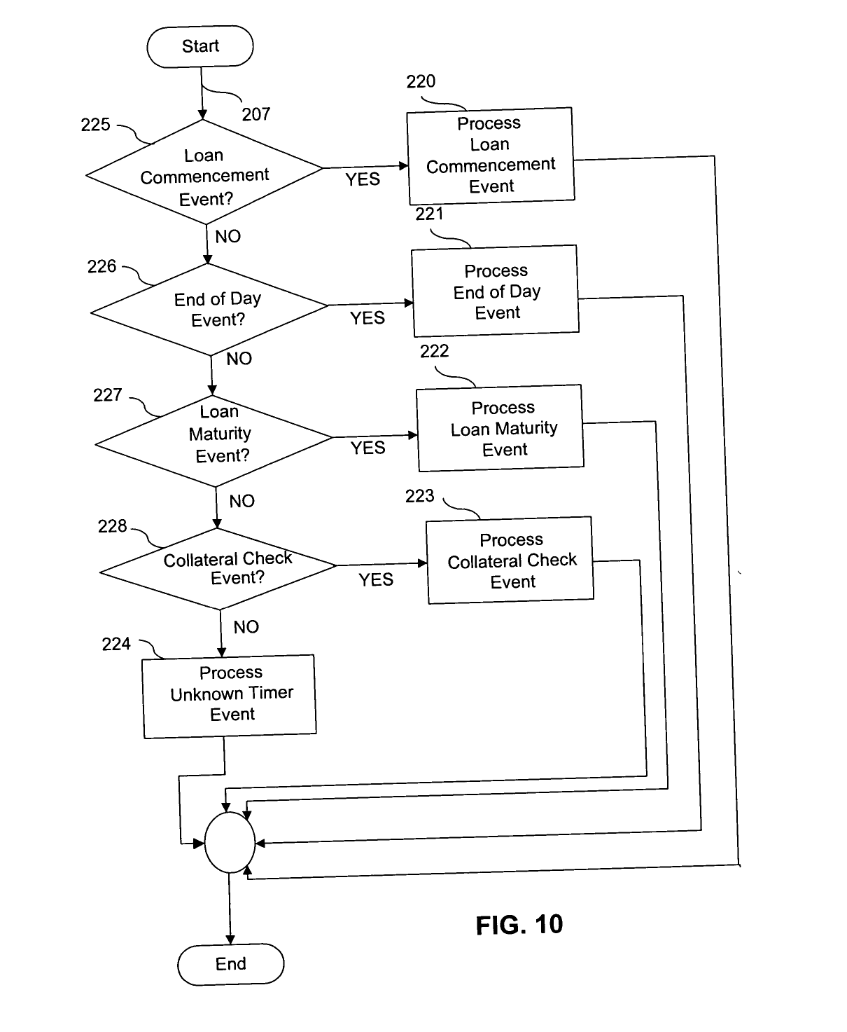

FIG. 10 is a flow chart of an exemplary process consistent with the Process Timer Event box illustrated in FIG. 9. The Process Timer Event 302 routine is called by the Event Processor 200 when a Timer Event 207 originating in the Timer Service 202 arrives. In the embodiment shown in FIG. 9, the Process Timer Event routine examines and classifies each type of Timer Event 207 and directs it to the proper processing routine. Specifically, the Process Loan Commencement Event routine 220 processes events that indicate commencement time for a particular loan (step 225, yes). The Process End of Day Event routine 221 processes events indicating that the end of a business day has occurred (step 226, yes). The Process Loan Maturity Event routine 222 processes events that indicate that a particular loan has reached maturity (step 227, yes). The Process Collateral Check Event routine 223 processes events that indicate that a particular collateral asset deposit is due (step 228, yes). And, the Process Unknown Timer Event routine 224 processes any Timer Event 207 that is not classified into one of the previous categories, including Timer Events that are regarded as errors (step 228, no).

Process Loan Commencement Event

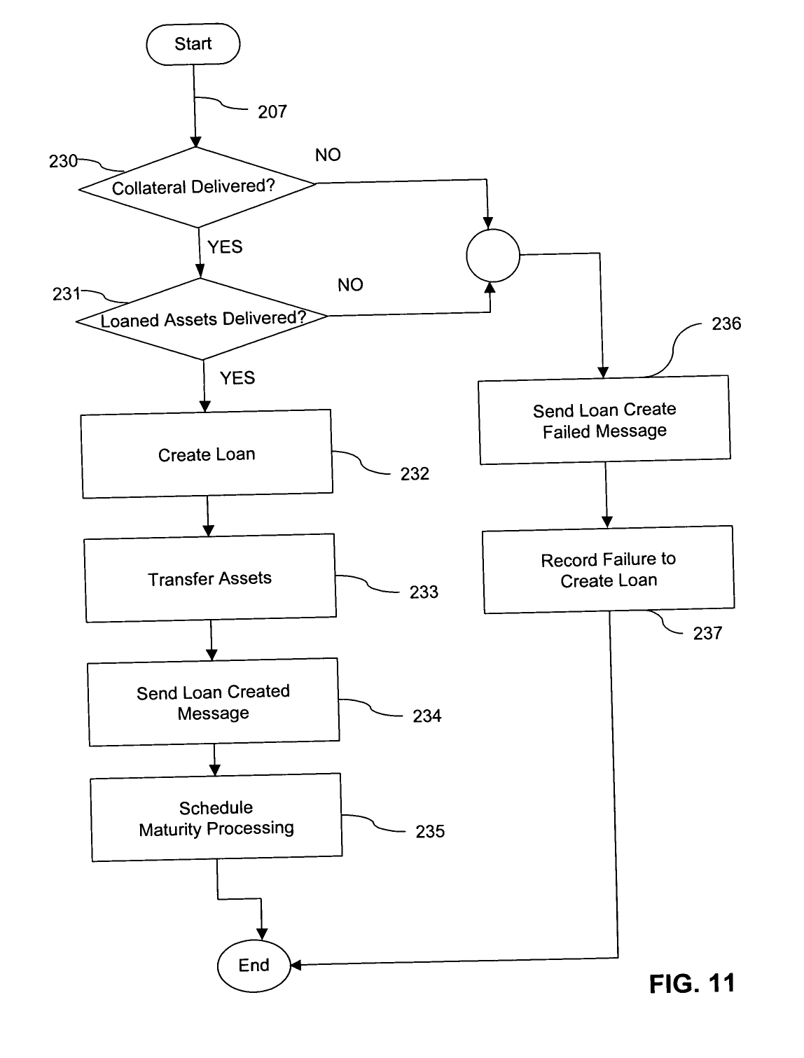

FIG. 11 is a flow chart of an exemplary process consistent with the Process Loan Commencement Event box illustrated in FIG. 10. In the embodiment shown, the Process Loan Commencement Event routine 220 begins processing when an event 207 arrives indicating that loan commencement processing for a particular loan should occur. The Process Loan Commencement Event routine 220 begins processing by checking to ensure that the borrower has deposited the initial collateral required under the loan by checking records kept of custodial event notifications (step 230). If the collateral deposit is verified (step 230, yes), a similar check is made to ensure that the lender has delivered the assets to be loaned (step 231).

If loaned asset delivery is also verified (step 231, yes), then the routine creates a lasting record of the loan (step 232); sends instructions to one or more Custodial Service Providers 107, for example using a software call to the appropriate Custodian Service Output Interface 203, to transfer the loaned assets to the borrower and the collateral assets to a collateral trust account, such as the operator's trust account (step 233); sends email messages, for example using a software call to the Email Server 131, to the borrower participant and the lender participant advising them that a loan has commenced and confirming the loan attributes and terms (step 234); and requests that a Maturity Processing Timer event be scheduled for delivery at the time the loan will mature, for example via a software call to the Timer Service 202 (step 235).

Turning again to the collateral delivery verification and loaned assets delivery verification (steps 230 and 231), if either is not delivered (step 230, no and step 231, no), then the routine sends email messages, for example via a software call to the Email Server 131, to the borrower and the lender indicating that the loan will not commence as planned (step 236); and makes a lasting record of the failed attempt to create a loan (step 237).

Process End of Day Event

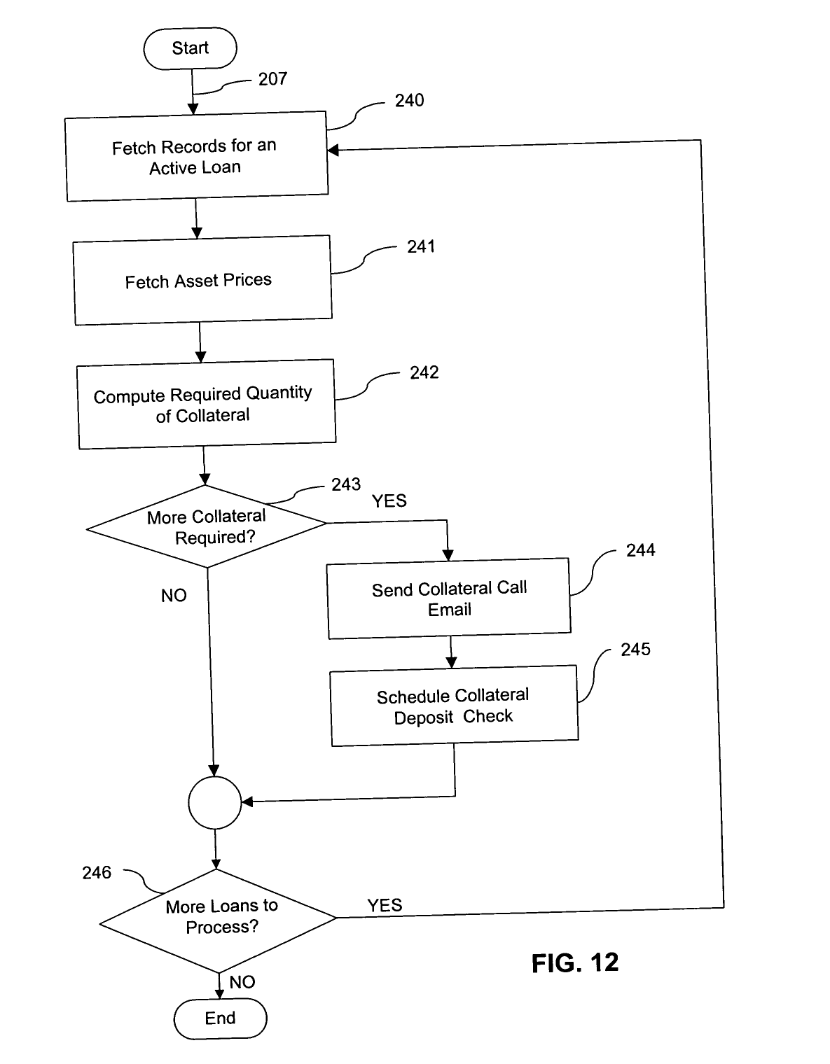

FIG. 12 is a flow chart of an exemplary process consistent with the Process End of Day Event box illustrated in FIG. 10. In the embodiment shown, when an event 207 arrives indicating that the end of day processing is required, the Process End of Day Event routine 221 begins a loop to process each active loan. Specifically, the routine fetches the records for an active loan (step 240); fetches the current market prices of the loaned and collateral assets associated with the loan from one or Market Data Service Providers 105, for example via a software call to one or more Market Data Service Query Interface modules 204 (step 241); computes the quantity of collateral required under the terms of the loan (step 242); and compares the quantity of collateral current held with the computed quantity of collateral required (step 243).

If more collateral is required (step 243, yes), then the routine sends an email, for example via a software call to the Email Server 131, to the borrower indicating how much more collateral is required and the deadline for providing the additional collateral (step 244), and calls the Timer Service 202 to schedule a Collateral Check Event on the additional collateral due deadline (step 245).

The Process End of Day Event routine continues processing the active loans until all the active loans are processed (step 246).

Process Loan Maturity Event

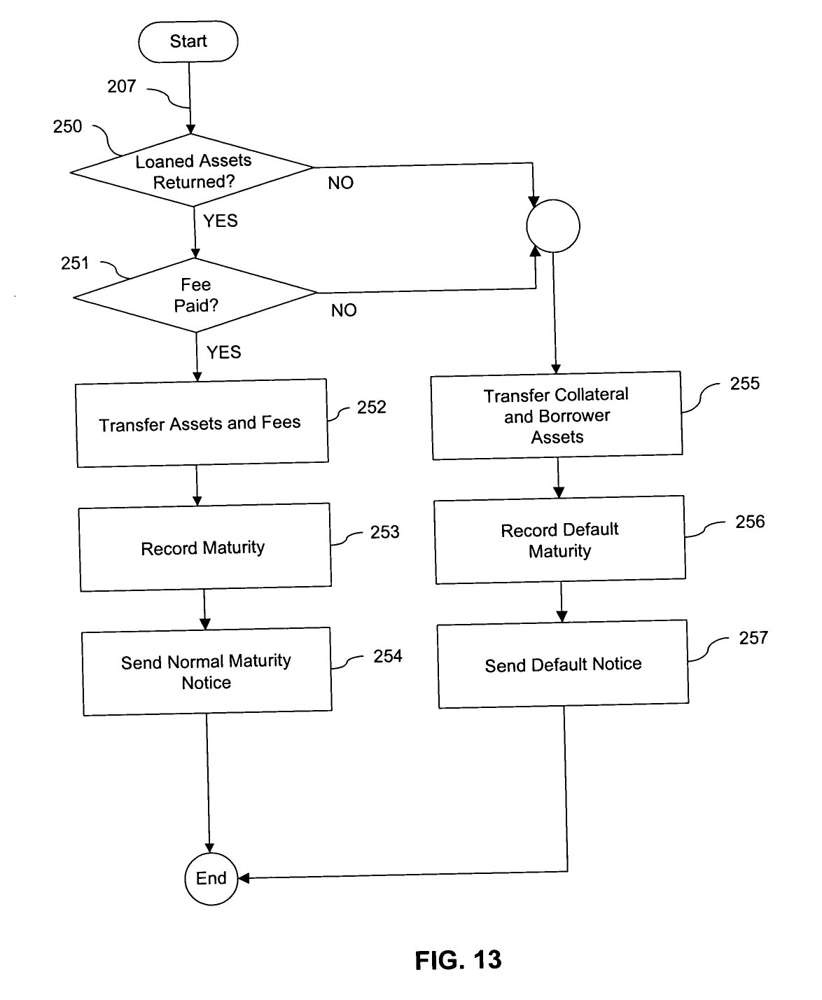

FIG. 13 is a flow chart of an exemplary process consistent with the Process Loan Maturity Event box illustrated in FIG. 10. In the embodiment shown, when a Timer Event 207 arrives indicating that a particular loan has reached its maturity date, the Process Loan Maturity Event routine 222 performs several functions to complete the loan transaction. To begin, the routine verifies that the borrower has transferred the loaned assets to the account of a custodian, such as the operator (step 250, yes) and verifies that the borrower has transferred the loan fee to a custodian account, such as that of the operator (step 251, yes). If both borrower transfers are complete, then the routine transfers the loaned assets and the loan fee from the custodian account to the lender's account and causes the transfer of any collateral assets held by the custodian to the borrower's account (step 252). These transfers may be accomplished, for example, by issuing instructions to one or more Custody Service Providers. Next, the routine makes a durable record of the loan's termination at maturity (step 253) and sends email messages, for example using a software call to the Email Server 131, to the borrower and the lender advising that the loan has been terminated as result of maturity (step 254).

Returning to the checks at step 250 and step 251, if either the loaned assets were not returned (step 250, no) or the loan fee was not paid (step 251, no) then the routine transfers the collateral assets associated with the loan from the account of the custodian, such as the operator, to the account of the lender, for example using appropriate instructions to one or more Custodial Service Providers holding the collateral assets (step 255). Similarly, any principal assets or loan fees already delivered by the borrower may be returned to the account of the borrower in this step. Next, the routine creates a lasting record of the termination of the loan due to default at maturity (step 256) and sends email messages, for example via a software call to the Email Server 131, to the borrower and the lender advising that the loan has been terminated as result of default at maturity (step 257).

Process Collateral Check Event

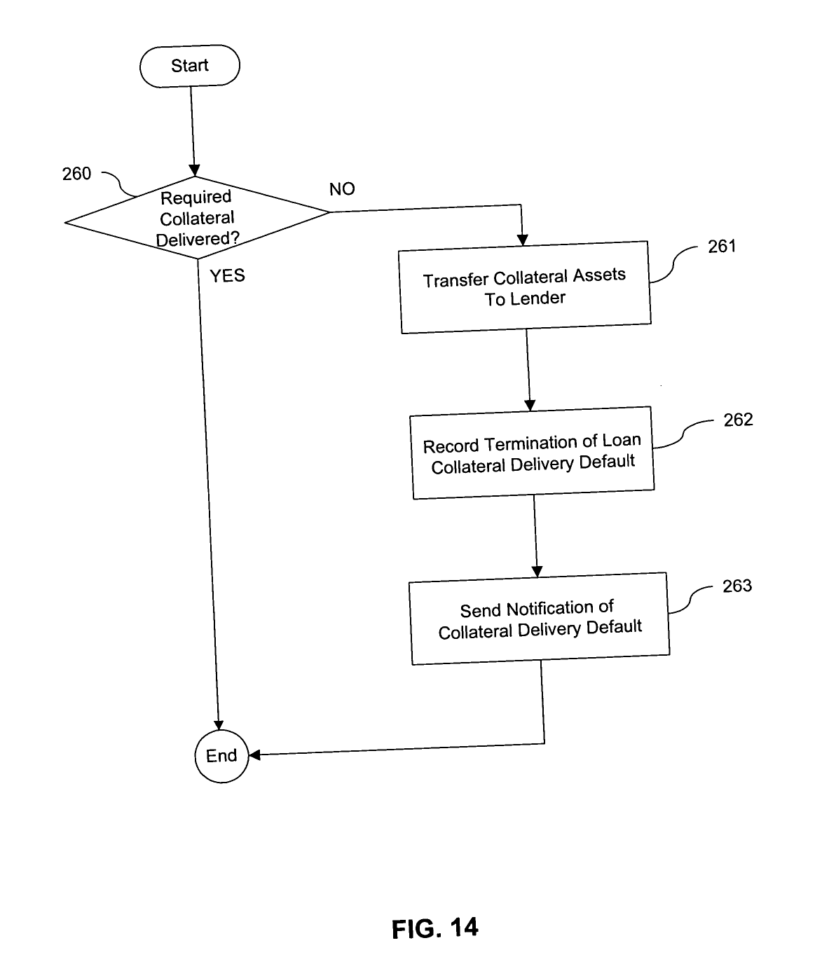

FIG. 14 is a flow chart of an exemplary process consistent with the Process Collateral Check Event box illustrated in FIG. 10. As shown in this embodiment, the Process Collateral Check Event routine 223 first checks the account of the custodian, such as the operator, to determine whether the required additional collateral has been delivered to the account (step 260). If so, then no further processing is done (step 260, yes). Otherwise (step 260, no) the routine transfers all the collateral assets associated with the loan held in the custodian's account to the account of the lender, typically by issuing appropriate transfer instructions to one or more Custodial Service Providers (step 261); creates a lasting record that the loan was terminated as a result of a collateral default (step 262); and sends email messages, for example using a software call to the Email Server 131, to the borrower and the lender notifying them that the loan has been terminated as a result of a collateral delivery default (step 263).

Process Web Request

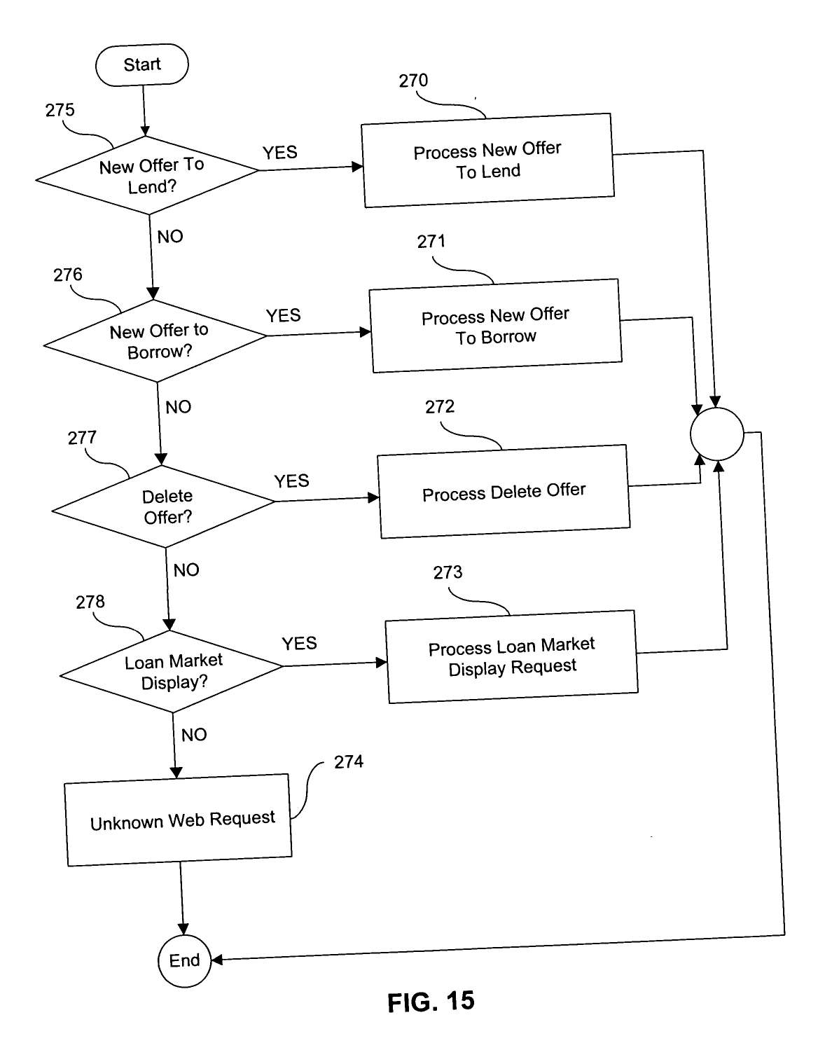

FIG. 15 is a flow chart of an exemplary process consistent with the Process Web Request box illustrated in FIG. 9. As shown for this embodiment, the Process Web Request routine 303 classifies and processes the web requests it receives. Specifically, if the web request is a request to process a New Offer to Lend (step 275, yes), the routine performs the Process New Offer To Lend function 270. If the web request is a request to process a New Offer to Borrow (step 276, yes), the routine performs the Process New Offer to Borrow function 271. If the web request is a request to process a Delete (or cancel) Offer (step 277, yes), the routine performs the Process Delete Offer function 272. If the web request is a request to process a Loan Market Data Request (step 278, yes), the routine performs the Process Loan Market Data Request function 273. The Process Loan Market Display Request routine 273 retrieves the pending offers to borrow and pending offers to lend and creates a report based on the retrieved information, such as that shown in FIG. 3. Otherwise, if a request other than those just mentioned is received (step 278, no), then the routine performs the Unknown Web Request function 274, which may include error processing.

Process New Offer To Lend and Process New Offer to Borrow

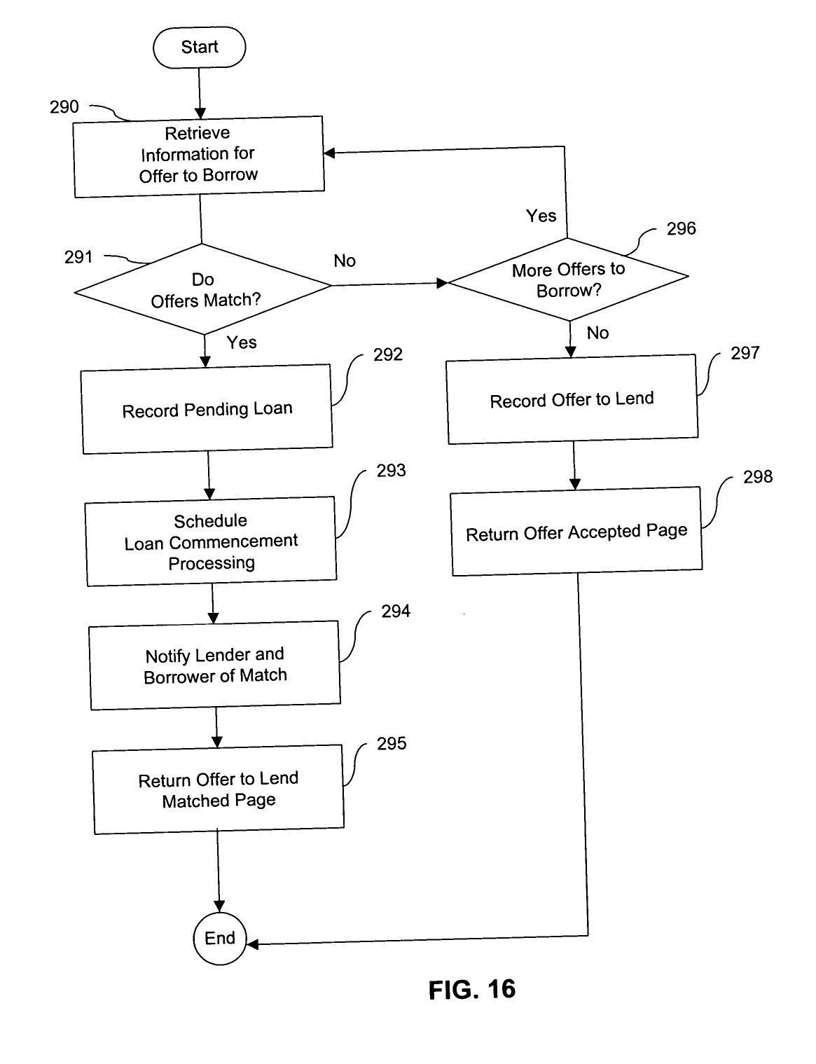

FIG. 16 is a flow chart of an exemplary process consistent with the Process New Offer To Lend box illustrated in FIG. 15. As shown for this embodiment, the Process New Offer To Lend routine 270 loops through the currently active offers to borrow (step 296 and 290) and compares each with the new offer to lend that has just been received to determine whether the two offers match (step 291). In one embodiment consistent with invention, the representative loop illustrated by steps 290, 291, and 296 is implemented by storing the active offers to borrow in a database, and the new offer to lend is used to form a query to the database that returns compatible offers to borrow from the database. In another embodiment consistent with the invention, the offers match (i.e., they are compatible) if all of the following conditions are met: the assets to be loaned are the same in both offers, the term is the same in both offers, the loan fee in the offer to borrow is as high or higher than the loan fee in the offer to lend, and the hair cut in the offer to borrow is as high or higher than the hair cut in the offer to lend. Other embodiments consistent with the invention determine a compatible match based on whether all the negotiable attributes are equal to or better than the borrower's offered terms, all the negotiable attributes are equal to or better than the lender's offered terms, or a specified subset of the negotiable attributes match.

In another embodiment consistent with the present invention, constraints are placed on the matching process to limit the exposure of a particular lender to a particular borrower. In such an embodiment the lender could set limits on the quantity of assets to be loaned to single borrower, and visa versa. Through this mechanism, a lender could create a diversified portfolio of loans with reduced risk.

If all the current offers to borrow are processed without a match (step 296, no), then the routine makes a record of the new offer to lend, marking it as an active offer to lend (step 297) and formats a response web page acknowledging to the offeror receipt of the offer and providing an identifier for the offer, which is sent to the participant who made the new offer to lend for display by a web browser (step 298). In one embodiment consistent with the invention, an offer remain valid in the marketplace until the offeror deletes it. In another embodiment, the offeror may set an expiration date for the offer, which date may or may not be available for inspection by other participants. In such an embodiment, the Offer Entry Dialog box 449 (shown in FIG. 2) may be modified to allow a participant to enter an offer expiration date.

If, on the other hand, a match is found between the new offer to lend and an active offer to borrow (step 291, yes), then the routine creates a durable record of a pending loan (step 292), computes the commencement date for the loan and calls the Timer Service 202 to schedule a Loan Commencement Event at that commencement date (step 293), emails messages, for example via a software call to the Email Server 131, to the borrower and the lender informing both of the pending loan and its commencement date (step 294), and formats a web page indicating the new offer has been matched to a borrower, which page is returned to the lender for web browser display (step 295).

The Process New Offer To Borrow routine 271 in FIG. 15 is very similar to the Process New Offer To Lend routine just described, except that the new offer to borrow is compared with pending offers to lend.

In one embodiment consistent with the present invention, the offer matching process is triggered by the arrival of each new offer to borrow or new offer to lend. In an alternative embodiment, the offer matching process could be triggered to occur at one or more specific points in time. In this alternative embodiment, offers would accumulate unmatched until the time appointed for conducting match making, at which time the offers are sorted and matched in bulk. Moreover, one of ordinary skill will recognize that many changes may be made to the described matching process without departing from the principles of the present invention. For example, all else being equal, the process may match a new offer with the oldest compatible active offer, instead of a more recent compatible pending offer, or certain negotiable attributes may be weighed more heavily than others in considering which of multiple compatible offers to use to make a match and create a loan transaction.

In another embodiment consistent with the present invention, after a match is found, a loan is created as a tri-party transaction between a lender participant, a borrower participant, and an operator, who acts as asset custodian, among other things. In an alternative embodiment, the loan transaction could be structured as a pair of bilateral transactions involving the operator as a common counter party. In this embodiment, a lender participant lends assets to the operator in one transaction and the operator then lends the assets to a borrower participant in a separate transaction. This alternative transaction structure permits the borrower and the lender to be more anonymous and permits the operator to adjust the credit risk borne by the parties.

In yet another embodiment consistent with the present invention, the collateral provided with respect to a loan is a specified quantity of a single class of asset, such as a United States Treasury Bond with a coupon of 6.0% maturing on Jan. 1, 2007. In an alternative embodiment, the collateral could be provided in the form of a portfolio of assets with each individual asset belonging to a broader asset class, such any obligation of the United States Treasury with a maturity of less than 5 years, or any corporate debt obligation issued by an issuer with BBB or better credit rating. In yet another embodiment, a lender may specify the desired collateral asset in terms of a quantity of a broad group of assets, for example 110% of the loaned asset's value in shares of common stock from any member company of the Standard and Poor's 500 Index.

Although the preceding embodiments of the invention were described in terms of components such as commercially available data processing apparatus, data communication facilities provided by one or more common carriers, commercially available application software, conventional databases, unique application software developed specifically to embody certain aspects of the invention, commonly available services provided by financial institutions, and a legal framework embodied by contracts and agreements between the legal entities comprising, operating, and using systems and methods consistent with the invention, one of ordinary skill will recognize that other embodiments consistent with the present invention may be easily formed using more, fewer, or different components and by combining the functions of components.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A system for managing a market for collateralized loans, comprising:
a database comprised of entries of borrowing and lending information, wherein each entry for borrowing information includes data identifying a desired loan asset, data identifying collateral for the desired loan asset, and a unique identification of a borrower, and wherein each entry for lending information includes a unique identification of a lender and data specifying conditions under which the lender will supply a loan to a borrower, and wherein the borrowing and lending information from the database is made available to borrowers and lenders; and
a computer for maintaining and querying the database and for receiving a query, and in response to the query, the computer:
determining whether the query constitutes an offer to borrow or an offer to lend an asset,
based on a result of the determination, locating in the database a set of entries that match attributes of the offer,
upon locating a match, creating a secured loan between any borrowers or lenders identified by the set of entries that match attributes of the offer and a borrower or lender specified by the offer, using any collateral identified in the set of entries that match attributes of the offer when it is determined that the query constitutes an offer to lend an asset and collateral identified in the query when it is determined that the query constitutes an offer to borrow, regardless of any determination concerning whether the borrower is able to repay the secured loan, and
notifying parties concerning the secured loan.

2. The system of claim 1, wherein the computer further performs:
servicing the secured loan according to the data specifying conditions under which the lender will supply a loan to a borrower.

3. A method of creating a market for collateralized loans comprising:
receiving a plurality of offers to borrow, wherein each offer to borrow has attributes including a desired loaned asset, a fungible collateral asset, and a borrower identity;
providing, to a plurality of lenders, information about the plurality of offers to borrow;
receiving a plurality of offers to lend, wherein each offer to lend has attributes including a loaned asset, a desired fungible collateral asset, and a lender identity;
providing, to a plurality of borrowers, information about the plurality of offers to lend;
matching an offer to lend from the plurality of offers to lend with an offer to borrow from the plurality of offers to borrow based solely on the attributes of the offer to lend and the attributes of the offer to borrow; and
creating a secured loan between a lender and a borrower if the lender's offer to lend matches the borrower's offer to borrow.

4. The method of claim 3, further comprising:
servicing the secured loan according to the attributes of the lender's offer to lend and the attributes of the borrower's offer to borrow.

5. The method of claim 4, wherein servicing the secured loan further comprises:
monitoring a value of the fungible collateral asset periodically; and
requesting an additional fungible collateral asset from the borrower if the value of the fungible collateral asset is less than a predetermined value.

6. The method of claim 4, wherein the secured loan has a term and wherein servicing the secured loan further comprises:
determining whether the secured loan has reached maturity according to the loan term;
determining whether the borrower has provided the loaned asset and a loan fee, when the loan reaches maturity; and
transferring the fungible collateral asset to the lender if the borrower has not provided the loaned asset and a loan fee when the loan reaches maturity.

7. The method of claim 3, wherein creating a secured loan further comprises:
transferring the loaned asset from the lender to an operator; and
transferring the loaned asset from the operator to a borrower.

8. The method of claim 3, wherein matching further comprises:
comparing the attributes of an offer to lend to the attributes of each of the plurality of offers to borrow when the offer to lend is received.

9. The method of claim 3, wherein matching further comprises:
comparing the attributes of each of the received plurality of offers to lend to the attributes of each of the plurality of offers to borrow at a predetermined time.

10. The method of claim 3, wherein the fungible collateral asset is a specified quantity of a specified homogenous asset, and wherein the specified homogenous asset is one of the group comprising: a specific common stock, a specific bond, and cash.

11. The method of claim 3, wherein the fungible collateral asset is a portfolio of various fungible assets.

12. A system for creating a market for collateralized loans comprising:
means for receiving a plurality of offers to borrow, wherein each offer to borrow has attributes including a desired loaned asset, a fungible collateral asset, and a borrower identity;
means for providing, to a plurality of lenders, information about the plurality of offers to borrow;
means for receiving a plurality of offers to lend, wherein each offer to lend has attributes including a loaned asset, a desired fungible collateral asset, and a lender identity;
means for providing, to a plurality of borrowers, information about the plurality of offers to lend;
means for matching an offer to lend from the plurality of offers to lend with an offer to borrow from the plurality of offers to borrow based solely on the attributes of the offer to lend and the attributes of the offer to borrow; and
means for creating a secured loan between a lender and a borrower if the lender's offer to lend matches the borrower's offer to borrow.

13. The system of claim 12, further comprising:
means for servicing the secured loan according to the attributes of the lender's offer to lend and the attributes of the borrower's offer to borrow.

14. The method of claim 13, wherein the means for servicing the secured loan further comprises:
means for monitoring a value of the fungible collateral asset periodically; and
means for requesting an additional fungible collateral asset from the borrower if the value of the fungible collateral asset is less than a predetermined value.

15. The system of claim 13, wherein the secured loan has a term and wherein the means for servicing the secured loan further comprises:
means for determining whether the secured loan has reached maturity according to the loan term;
means for determining whether the borrower has provided the loaned asset and a loan fee, when the loan reaches maturity; and
means for transferring the fungible collateral asset to the lender if the borrower has not provided the loaned asset and a loan fee when the loan reaches maturity.

16. The system of claim 12, wherein the means for creating a secured loan further comprises:
means for transferring the loaned asset from the lender to an operator; and
means for transferring the loaned asset from the operator to a borrower.

17. The system of claim 12, wherein the means for matching further comprises:
means for comparing the attributes of an offer to lend to the attributes of each of the plurality of offers to borrow when the offer to lend is received.

18. The system of claim 12, wherein the means for matching further comprises:
means for comparing the attributes of each of the received plurality of offers to lend to the attributes of each of the plurality of offers to borrow at a predetermined time.

19. The system of claim 12, wherein the fungible collateral asset is one of the group comprising: a specific common stock, a specific bond, cash, and a portfolio of various fungible assets.

20. A computer program product for creating a market for collateralized loans including code for causing a processor to perform a process comprising:
receiving a plurality of offers to borrow, wherein each offer to borrow has attributes including a desired loaned asset, a fungible collateral asset, and a borrower identity;
providing, to a plurality of lenders, information about the plurality of offers to borrow;
receiving a plurality of offers to lend, wherein each offer to lend has attributes including a loaned asset, a desired fungible collateral asset, and a lender identity;
providing, to a plurality of borrowers, information about the plurality of offers to lend;
matching an offer to lend from the plurality of offers to lend with an offer to borrow from the plurality of offers to borrow based solely on the attributes of the offer to lend and the attributes of the offer to borrow; and
creating a secured loan between a lender and a borrower if the lender's offer to lend matches the borrower's offer to borrow.
